(19) United States
(12) Patent Application Publication
(10) Pub. No.: US 2004/0175983 A1
(43) Pub. Date: Sep. 9, 2004

(54) Roll-a-seal

(76) Inventor: Jon M. Davis, Key Largo, FL (US)

Correspondence Address: Jon M. Davis, 273 Loeb Avenue, Key Largo, FL, 33037, US

(21) Appl. No.: 10/376,531

(22) Filed: Mar. 3, 2003

(51) Int. Cl. H01R 13/62

(52) U.S. Cl. 439/369

(57) ABSTRACT

A latex rubber cover molded to the base of the plugs on a construction type extension cord. When not in use, it is rolled back like rolling up the sleeve of a long sleeved shirt. When two cords with the latex cover are plugged into each other to make a longer cord, the latex cover on one plug is rolled onto itself and then onto the joined plug. When the cover is fully rolled out covering both plugs tightly, the latex cover on the joined plug is rolled out onto itself and the joined plug and on top of the first latex cover thus giving it a double seal on the joined plugs creating a waterproof joining of two extension cords. This also prevents the two plugs from pulling apart when being extended while being used.

### FIELD OF THE INVENTION

This invention relates to the safer and more convenient use of heavy duty or construction type extension cords when joining two or more extension cords together and using them to power an electrical product such as tools, machinery or lights.

### BACKGROUND OF THE INVENTION

Extension cords are used to expand the working area when working with electrical products. Sometimes they are used in wet environments and this can cause a safety hazard by electrocution. Keeping water away from the exposed electric connections such as extension cord plugs can be difficult In part, because of this problem Ground Fault Interrupter outlets and breakers were created. When used, Ground Fault Interrupters will trip or stop electric current from flowing to equipment so fast it prevents serious electrical injury. When used in a wet environment, the Ground Fault Interrupter can trip so many times it disrupts the use of electric tools to the point of causing work to stop until drier conditions exist. I created the Roll-A-Seal plug to prevent these problems. This invention makes extension cord connections waterproof. When electric connections are encapsulated by the Roll-A-Seal product, water or other liquids cannot get to the electrical contacts eliminating the safety and convenience problems that can be otherwise experienced. Electric connections on extension cords are subject to corrosion when they get wet and cords with dampness in the plugs cannot be used when used with Ground Fault Interrupter outlets. These cords must be allowed to dry thoroughly before again being used when Ground Fault Interrupter outlets are being used. This can take several days and can cause the necessity of having many extension cords on hand. Roll-A-Seal was designed to prevent these problems. When two or more extension cords are being used, to prevent the cord plugs from pulling apart and separating, they are often tied together by various means. Sometimes this puts a strain on the area where the cord joins the plug. Roll-A-Seal holds the joined plugs together in the most efficient way possible by friction grip and in their intended position. This invention creates a simple, safe and convenient way to join two or more extension cords together.

### SUMMARY OF THE INVENTION

This invention has taken construction type extension cords and made them safer, more convenient with simple modification in adding a molded latex cover fused to its base so it can be rolled out like rolling down a shirt sleeve onto itself and a joined plug creating a water proof seal and a means to securely hold the joined plugs together until they are unrolled to separate. This invention can save time, lives and money.

### BRIEF DESCRIPTION OF THE DRAWINGS

FIG. 1 shows the 1/16 inch thick latex sleeve rolled up into itself.

FIG. 2 shows the female plug of the extension cord not covered by the latex sleeve and not joined to the male plug.

FIG. 3 shows the male plug of the extension cord not covered by the latex sleeve and not joined to the female plug.

FIG. 4 shows the 1/16 inch thick latex sleeve rolled up into itself.

FIG. 5 shows the 1/16 inch thick latex sleeve on the female plug rolled up into itself.

FIG. 6 shows the male and female plugs joined together with the male latex sleeve rolled out onto and covering both plugs.

FIG. 7 shows the latex sleeve of the male plug rolled out over itself and onto the female plug covering both of them.

FIG. 8 shows the latex sleeve of the female plug rolled out over the latex sleeve of the male plug creating a double seal over both the male and female plugs which are joined together.

FIG. 9 shows the male and female pugs joined together and encapsulated by both latex sleeves.

FIG. 10 shows the male plug with its latex sleeve covering itself and the female plug and the latex sleeve of the female plug over the male sleeve completing the waterproof seal.

### DESCRIPTION OF THE PREFERRED EMBODIMENT

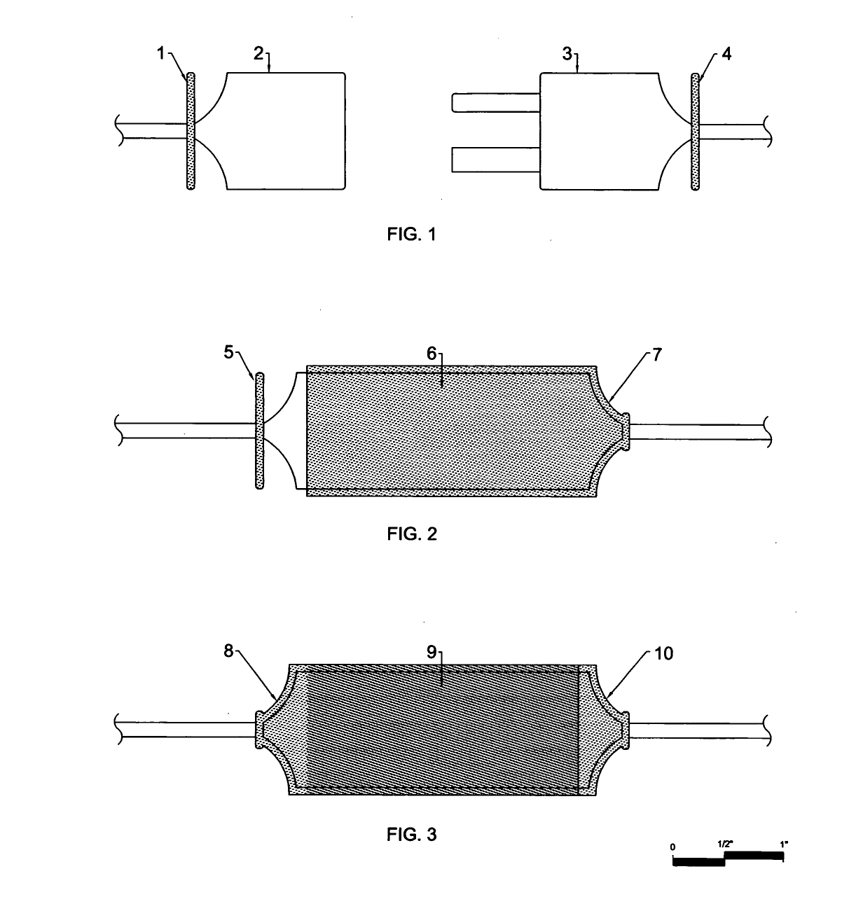

The shown embodiments illustrated in FIGS. 1 and 2 show the female plug by itself with the 1/16 inch thick latex sleeve in its unused condition but allowing the extension cord to function to conduct electricity from a power source to an electrical product. FIGS. 3 and 4 show the male plug in the same condition. FIGS. 5, 6 and 7 show the first step of the procedure in sealing the male and female plugs now joined with the male latex sleeve fully extended creating a friction bond over the two plugs. FIGS. 8, 9 and 10 show the male and female plugs joined, encapsulated by two layers of 1/16 inch thick latex rubber sleeves which create a waterproof seal and friction bond holding the two plugs together. This creates in effect, one extension cord that can be used in wet environments and submerged in water without water causing a safety or convenience problem.

### BRIEF DESCRIPTION OF THE DRAWINGS

FIG. 1, number 1 shows the 1/16 inch thick latex sleeve rolled up into itself.

FIG. 1, number 2 shows the female plug of the extension cord not covered by the latex sleeve and not joined to the male plug.

FIG. 1, number 3 shows the male plug of the extension cord not covered by the latex sleeve and not joined to the female plug.

FIG. 1, number 4 shows the 1/16 inch thick latex sleeve rolled up into itself.

FIG. 2, number 5 shows the 1/16 inch thick latex sleeve on the female plug rolled up into itself.

FIG. 2, number 6 shows the male and female plugs joined together with the male latex sleeve rolled out onto and covering both plugs.

FIG. 2, number 7 shows the latex sleeve of the male plug rolled out over itself and onto the female plug covering both of them.

FIG. 3, number 8 shows the latex sleeve of the female plug rolled out over the latex sleeve of the male plug creating a double seal over both the male and female plugs which are joined together.

FIG. 3, number 9 shows the male and female pugs joined together and encapsulated by both latex sleeves.

FIG. 3, number 10 shows the male plug with its latex sleeve covering itself and the female plug and the latex sleeve of the female plug over the male sleeve completing the waterproof seal.

What is claimed is:

1. The latex cover which is molded to the base of both male and female plugs on a construction type extension cord is used to create a waterproof plug connection when joining two or more extension cords together. This creates a safety factor when used in a wet environment. When moisture invades an electrical connection to which an electric tool or machine is being used by a person, the person is exposed to the possibility of electrocution especially if there is not a proper electrical ground on the cord or the tool or machine.

2. The latex cover for the extension cord plugs, when rolled out and in place, also helps prevent the separation of the two or more extension cords when they are joined together. This eliminates the need to tie the two cords together which puts a strain on the connection of the plugs to the electric cord.

3. The latex cover, when in place, helps prevent corrosion of the metal plug contacts and electrolysis if submerged in water while electric current is moving through the wires.
